(19) United States
(12) Patent Application Publication
(10) Pub. No.: US 2014/0326120 A1
(43) Pub. Date: Nov. 6, 2014

(54) DEVICE WITH MULTIPLE CUTTING ELEMENTS USED IN FOLDING MACHINE

(71) Applicants: Seoul Laser Dieboard System Co., Ltd., San Diego, CA (US); Seoul Laser Dieboard System Co., Ltd., Kyong-gi-Do (KR)

(72) Inventor: Sang Moo Lee, Kyong-gi-do (KR)

(21) Appl. No.: 14/333,410

(22) Filed: Jul. 16, 2014

Related U.S. Application Data
(63) Continuation of application No. 13/133,135, filed on Jan. 10, 2012, now abandoned.

(30) Foreign Application Priority Data
Nov. 6, 2007 (KR) 10-2007-0112814

(51) Int. Cl. B26D 7/01; B26F 1/20

(52) U.S. Cl. CPC B26D 7/01; B26F 1/20
USPC 83/440.1

(57) ABSTRACT

A device, comprising: a base plate configured to be moveable toward and back from a metal rule having at least one flanged side, wherein the metal rule is fed into the device along a metal rule feeding path; a first plate coupled to the base plate, the first plate including a plurality of cutter holes formed on its surface; a plurality of cutting elements configured to engage the corresponding plurality of cutter holes on the first plate to make cuts on the at least one flanged side of the metal rule.

### CROSS-REFERENCE TO RELATED APPLICATIONS

This application is a continuation of Ser. No. 13/133,135 tiled on Jan. 10, 2012, which is a National Stage Entry of PCT Application No. PCT/US2008/079637 filed on Oct. 10, 2008 which claims the benefit of priority of Korean Patent Application No. 10-2007-112814, filed Nov. 6, 2007. The disclosure of the above-referenced patent applications is incorporated herein by reference.

### BACKGROUND

1. Field of the Invention

The present invention relates to a device with multiple cutting elements, and more particularly, to a folding machine having such a device with multiple cutting elements.

2. Background

FIG. 1 shows a conventional machine 1 for folding a metal strip or rule 10 of a flat type into a predetermined shape. The structure and operation of a typical conventional machine is described in Korean Patent Registration No. 10-0233335, filed Nov. 20, 1996; and Korean Patent Registration No. 10-388889, filed Apr. 3, 1999. However, the conventional folding machine 1 shown in FIG. 1 can be used mostly for folding flat metal strip or rule. Thus, to fold a metal strip or rule of other shapes, a new design is desirable.

### SUMMARY

In one aspect, a cutting device is disclosed. The cutting device includes: a base plate configured to be moveable toward and back from a metal rule having at least one flanged side, wherein the metal rule is fed into the device along a metal rule feeding path; a first plate coupled to the base plate, the first plate including a plurality of cutter holes formed on its surface; a plurality of cutting elements configured to engage the corresponding plurality of cutter holes on the first plate to make cuts on the at least one flanged side of the metal rule.

In one embodiment, the plurality of cutting elements is arranged in a circular pattern with each cutting element spaced at a predetermined distance from adjacent cutting elements. In another embodiment, the first plate is axially coupled to the base plate and is configured to be rotatable about a longitudinal axis of the base plate

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings.

FIG. 1 is a perspective view illustrating a conventional folding machine.

FIGS. 2A, 2B, 2C show metal rules having flanged sides wherein the rules are used to make channel letters for sign boards.

FIG. 3 illustrates a folding machine including: a device with multiple cutting elements; a metal rule folding unit; and a metal rule feeding path; in accordance with one embodiment of the present invention.

FIG. 4 shows the flanged side of a metal rule cut in a predetermined shape.

FIG. 5 shows one example of the desired shape of the final product produced from bending the metal rule with cuts made on the flanged side.

FIG. 6 shows a detailed perspective view of a device with multiple cutting elements.

FIG. 7 is a perspective view illustrating the main part of a device multiple cutting elements in which the base plate has been moved to a position next to a metal rule feeding path so that the cutting elements can cut the flanged side of the metal rule.

FIG. 8 is a side view of the main part of the device as shown in FIG. 7.

FIG. 9 is a perspective view illustrating the main part of a device with multiple cutting elements in which the base plate has been moved to a position away from the metal rule feeding path so as to allow the metal rule to move along the metal rule feeding path.

FIG. 10 is a side view of the main part of the device as shown in FIG. 9.

FIG. 11 is a perspective view illustrating the main part of a device with multiple cutting elements showing a cut made on the flanged side of a metal rule.

FIG. 12 is a top view illustrating the process of cutting the flanged side of a metal rule.

FIG. 13 shows an alternative configuration of the base plate with multiple cutting elements.

### DETAILED DESCRIPTION

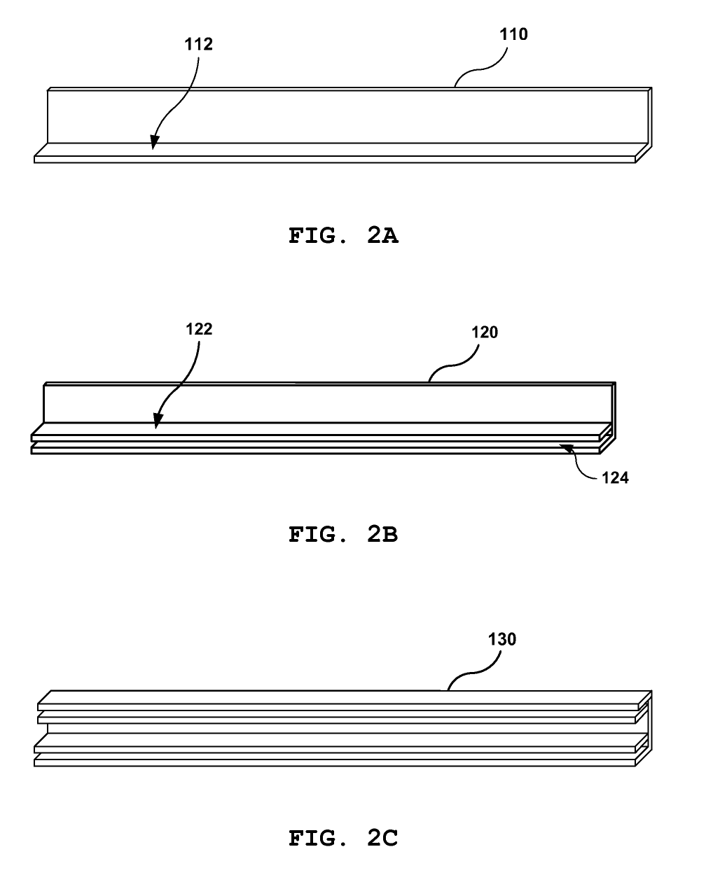

Certain embodiments as disclosed herein provide for a device having multiple cutting elements that are driven efficiently using a limited space, References will be made in detail to these embodiments including examples illustrated in the accompanying drawings. Technical structure and operation of the device will be described with reference to the drawings in FIGS. 2 through 13.

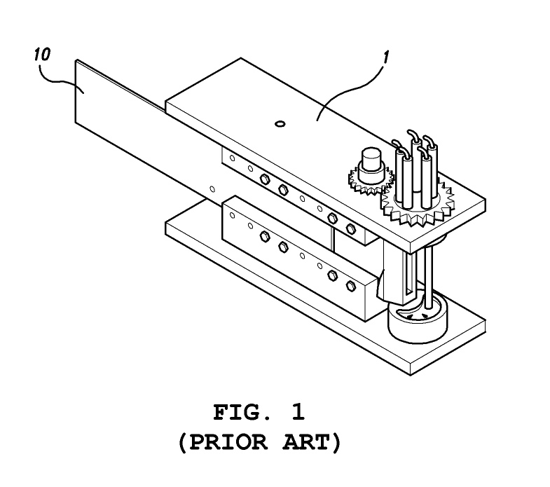

As described above, conventional folding machines have structural difficulties in folding metal rules (or strips) of shapes that are not flat. For example, the conventional folding machine shown in FIG. 1 would have difficulty folding metal rules 110, 120 that have flanged or angulated side(s) 112, 122 as shown in FIGS. 2A and 2B. In some embodiments, the metal rule of the shapes illustrated in FIGS. 2A and 2B can be used to make channel letters for sign boards.

In one embodiment, a gap 124 in the double flanged side 122 of FIG. 2B can be used to insert a back panel once the metal rule 120 has been folded into a desired shape or letter. In another embodiment, the metal rule 130 of a shape shown in FIG. 2C can be used to insert front and back panels into gaps created by two double flanged sides once the desired shape or letter has been achieved. In other embodiments, other shapes of the metal rule can be used to make channel letters for sign boards.

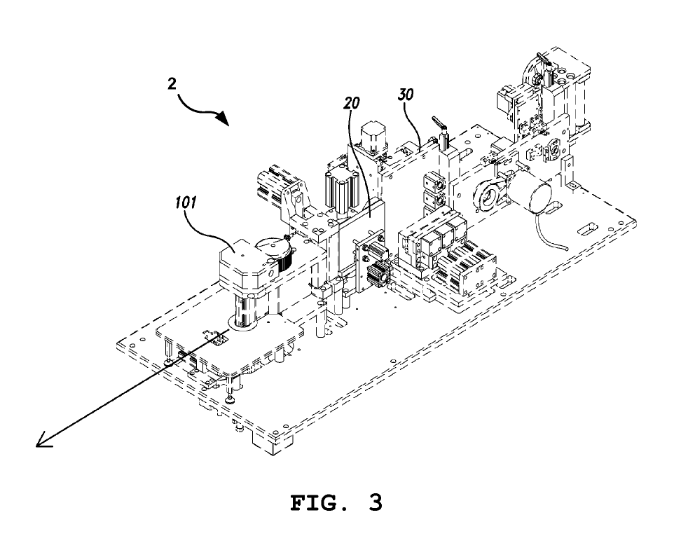

FIG. 3 illustrates a folding machine 2 including: a device 20 with multiple cutting elements; a metal rule folding unit 101; and a metal rule feeding path 30; in accordance with one embodiment of the present invention. The folding machine 2 of FIG. 3 is configured to fold metal rules having flanged or angulated side(s) 112, 122 as shown in FIGS. 2A, 2B, and 2C. Thus, the device 20 with multiple cutting elements is provided upstream from the metal rule folding unit 101 so that the flanged side(s) 112, 122 of the metal rule can be fed along the metal rule feeding path 30 and cut by the device 20 with multiple cutting elements prior to being folded by the folding unit 101.

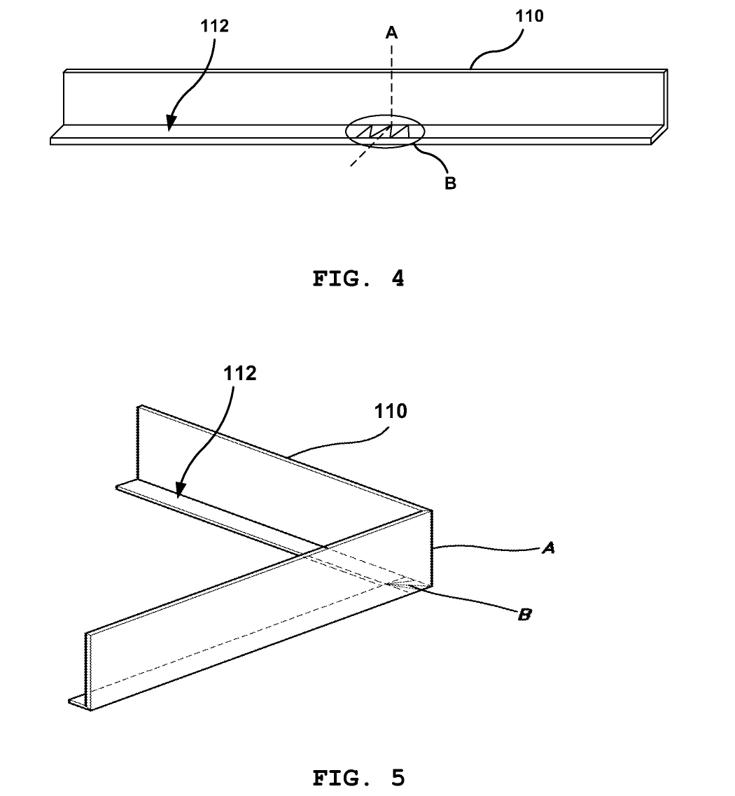

To describe the above process in detail, FIG. 4, for example, shows a metal rule 110 having a flanged side 112. This metal rule 110 is fed along the metal rule feeding path 30 in the direction shown in FIG. 3. The flanged side 112 of the metal rule 110 is then cut by the device 20 with multiple cutting elements. FIG. 4 shows the flanged side 112 of the metal rule 110 cut in a predetermined shape (see Part B) prior to Line A reaching the metal rule folding unit 101. Thus, cutting the flanged side 112 in a predetermined shape prior to reaching the metal rule folding unit 101 allows the metal rule 110 to be folded easily and produces a smooth shape for the final product (e.g., a channel letter). The angle(s) of the cut is predetermined by the desired shape of the final product. For example, the top tip of the letter A (e.g., an outer bend angle of approximately 315 degrees) would require greater angle cut than the bend in the letter L (e.g., an outer bend angle of approximately 270 degrees).

FIG. 5 shows one example of the desired shape of the final product produced from bending the metal rule 110 with cuts made on the flanged side 112. In the illustrated embodiment, the cuts were made in Part B of the flanged side 112, and the metal rule 110 was folded over along Line A. Thus, FIG. 5 shows that the metal rule 110 can be easily folded in a right angle because of the cuts made in the flanged side 112 of the metal rule 110. Thus, it can be seen that by making different angle cuts on the flanged side 112 of the metal rule 110, any shape of channel letters can be produced using flanged metal rules. In some embodiments, when the channel letters are produced, the flanged side 112 acts as a support for the back panel. In other embodiments, the flanged side 112 acts as a support for the front side panel.

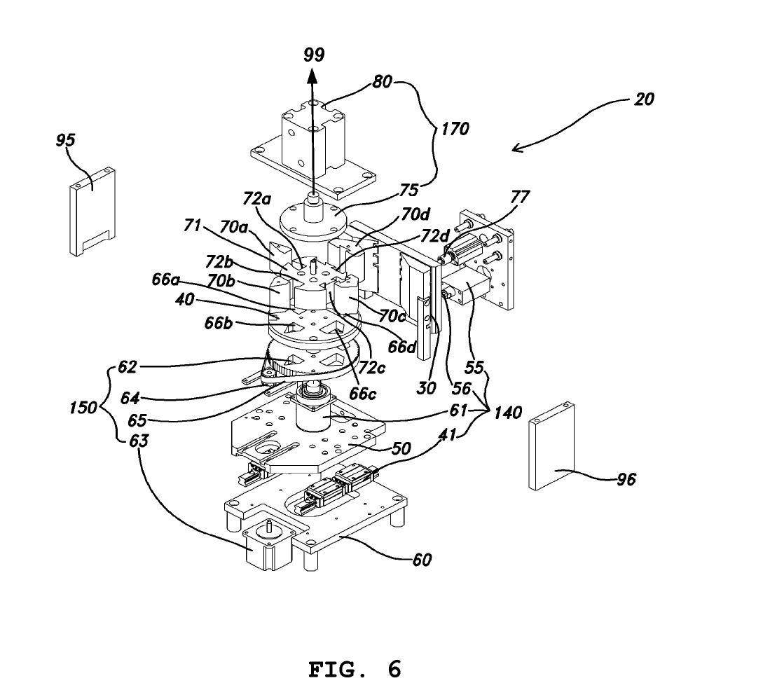

FIG. 6 shows a detailed perspective view of the device 20 with multiple cutting elements. In the illustrated embodiment, the device 20 includes a base plate 50 located above a lower support plate 60, In one embodiment, the base plate 50 is moveable. In another embodiment, the base plate 50 is fixed.

In the illustrated embodiment, a slide rail 41 is coupled between the base plate 50 and the lower support plate 60. The base plate 50 is coupled to a rod 56 of a first cylinder 55 so that the plate 50 can move back and forth along the slide rail 41 in a direction substantially perpendicular to the metal rule feeding path 30. Thus, the slide rail 41 and the first cylinder 55 are configured as a driving part 140 of the base plate 50 so that the cutting elements can be driven in and out towards the flanged side of the metal rule.

In one embodiment, the base plate 50 can be moved back and forth using a mechanism other than a slide rail. For example, the base plate 50 can be configured to rotate on the lower support plate 60 so that the base plate 50 and the device 20 can be circularly moved toward and back from the flanged side of the metal rule. In another embodiment, the base plate 50 is fixed in a position where the flanged side of the metal rule can slide under the cutting elements.

A bearing 61 is positioned on the base plate 50, and a first gear 62 is positioned on an axle of the bearing 61. A first plate 40 is situated at a predetermined distance above the first gear 62. Thus, the bearing 61 acts as a support for the rotation of the first plate 40. In one embodiment, the first plate 40 is rotatable. In another embodiment, the first plate 40 is rotatable about a longitudinal axis 99 as shown in FIG. 6. In yet another embodiment, the first plate 40 is fixed so that the first plate 40 does not rotate. In yet another embodiment, the first plate 40 is circular in shape as shown in the figures. In a further embodiment, the first plate 40 and the first gear 62 are moved substantially as a single body.

Further, a motor 63 is provided below the base plate 50, and a second gear 64 is fixed to an axle of the motor 63. A timing belt 65 is secured around the first gear 62 and the second gear 64. In one embodiment, the first gear 62 and the first plate 40 are rotated substantially simultaneously with respect to the axle of the bearing 61 in a rotational direction of the second gear 64. The motor 63, the bearing 61, the first gear 62, the second gear 64, and the timing belt 65 form a first plate driving part 150. In another embodiment, the timing belt 65 can be configured with any type of driving/coupling mechanism(s) that couples the rotation of the second gear 64 to the first gear 62. In yet another embodiment, the first plate 40 is moved or rotated by the first gear 62 (and a motor) without the aid of the driving mechanism or the second gear 64.

In the illustrated embodiment, a cutter guide 71 is further coupled to the first plate 40. The cutter guide 71 includes guide grooves 72a, 72b, 72c, and 72d arranged at a predetermined interval (and in synchronization with cutter holes 66a, 66b, 66c and 66d on the first plate 40) around the guide 71. In one embodiment, the interval between each groove may vary. The guide grooves 72a, 72b, 72c, and 72d are configured to allow a plurality of cutting elements 70a, 70b, 70c, and 70d, respectively, to slide up and down the guide groves 72a, 72b, 72c, and 72d. Cutter holes 66a, 66b, 66c and 66d are formed on the first plate 40 to have the same sectional shape as that of the plurality of cutting elements 70a, 70b, 70c, and 70d, respectively. It should be noted that each cutting element is of different size so that the device 20 with multiple cutting elements can cut the flanged side of metal rule with several different angles without having to insert new cutter each time. In one embodiment, the interval between each cutting element may vary. In another embodiment, the interval between each cutting element may be constant.

The cutting elements 70a, 70b, 70c and 70d are fixed to a circular cutter fixing body 75, which is fixed to a rod of a second cylinder 80. Since the circular cutter fixing body 75 is operated along a rotational axis 99 of the first plate 40, the rod of the second cylinder 80 can be secured on the cutter fixing body 75 so as not to apply rotational load to the rod of the second cylinder 80. This can be done to protect the second cylinder 80 from damage. The second cylinder 80 is coupled to supports 95 and 96, which are provided on both sides of the base plate 50. The cutter fixing body 75 and the second cylinder 80 form a cutter driving part 170.

The device 20, including the first plate 40, the plurality of cutting elements 70a, 70b, 70c and 70d, and the base plate 50, is configured to move forward and back in a substantially perpendicular direction with respect the metal rule feeding path 30 by means of the base plate driving part 140. As described above, the first plate 40 (along with the plurality of cutting elements 70a, 70b, 70c and 70d) is rotationally driven by the circular driving part 150; the plurality of cutting elements 70a, 70b, 70c and 70d is provided to move up and down along the guide grooves 72a, 72b, 72c and 72d of the cutter guide 71 (i.e., along a longitudinal axis 99 of the base plate as shown in FIG. 6) by the cutter driving part 170.

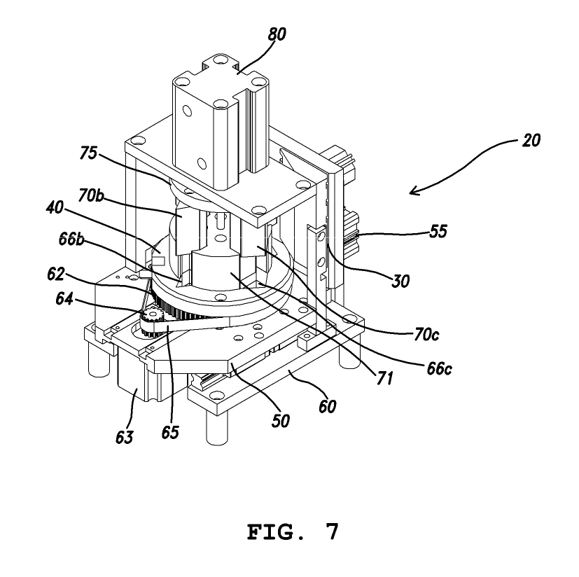

The operation of the device 20 with multiple cutting elements is described below in detail with respect to FIG. 7 to FIG. 12.

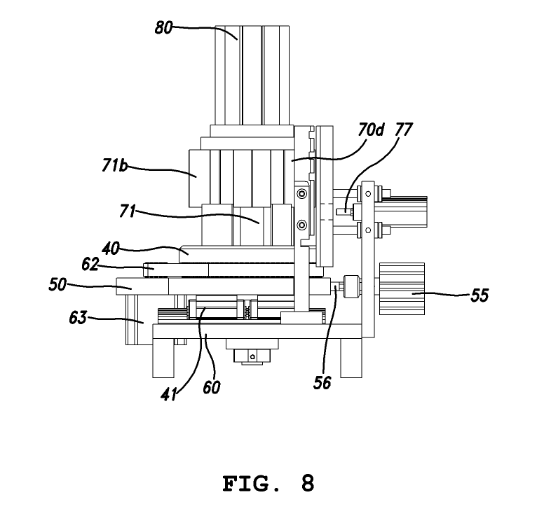

FIG. 7 is a perspective view illustrating the main part of the device 20 in which the base plate 50 has been moved to a position next to the metal rule feeding path 30 so that the cutting element(s) can cut the flanged side of the metal rule. FIG. 8 is a side view of the main part of the device 20 as shown in FIG. 7.

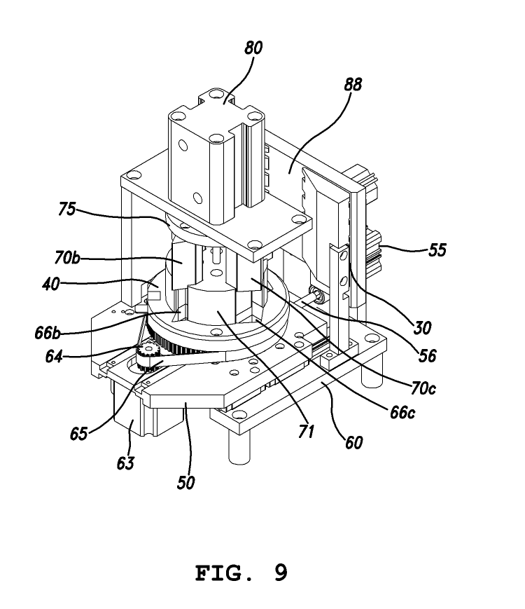

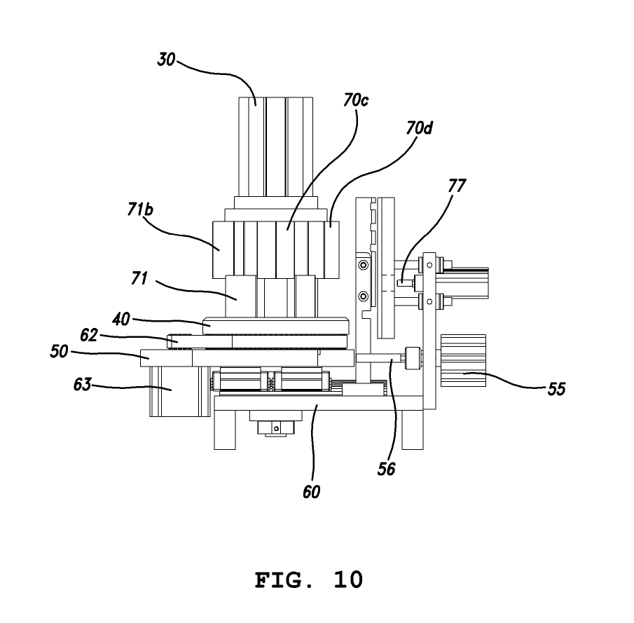

FIG. 9 is a perspective view illustrating the main part of the device 20 in which the base plate 50 has been moved to a position away from the metal rule feeding path 30 so as to allow the metal rule to move. FIG. 10 is a side view of the main part of the device 20 as shown in FIG. 9.

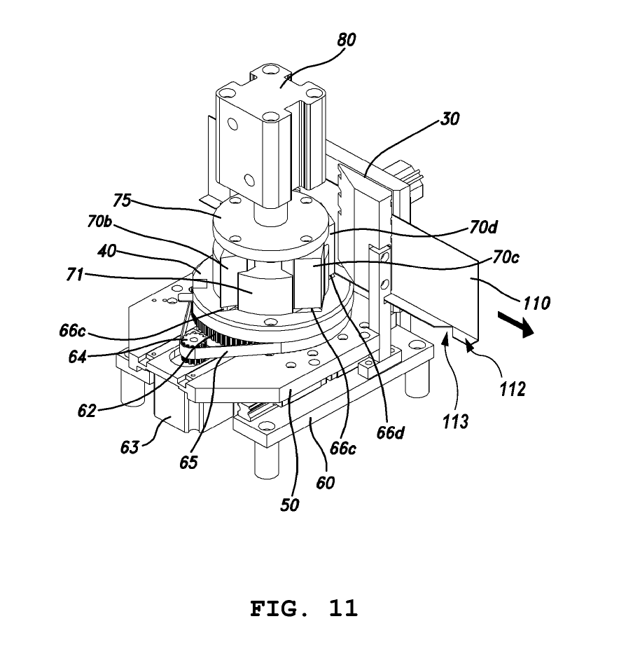

FIG. 11 is a perspective view illustrating the main part of the device 20 showing a cut 113 made on the flanged side 112 of the metal rule 110.

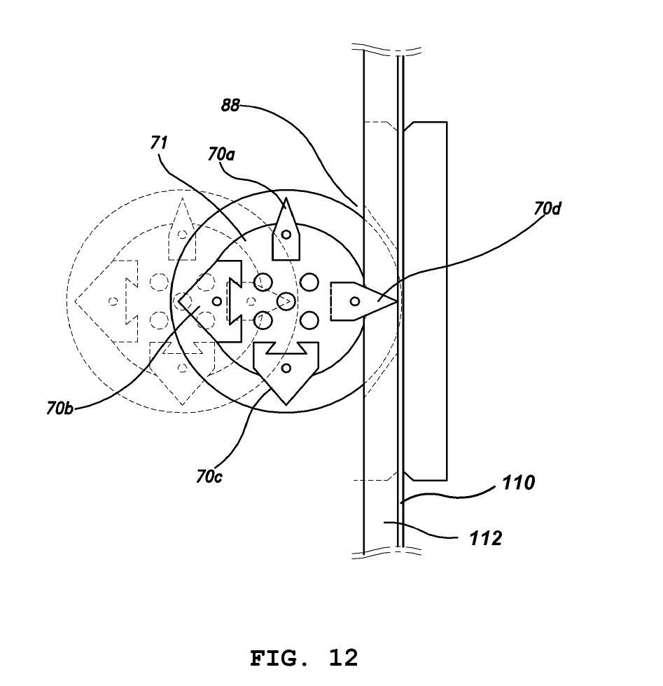

FIG. 12 is a top view illustrating the process of cutting the flanged side 112 of the metal rule 110.

In one embodiment of its operation, the device 20 with multiple cutting elements: moves the metal rule 110 with flanged side(s) a predetermined distance along the metal rule feeding path 30; or stops the metal rule 110 if a sensor (not shown) senses that the cutting position has been reached. In this embodiment, the first plate 40 is rotated to select one of the cutting elements 70a, 70b, 70c, and 70d so that the selected cutting element (e.g., 70d in FIG. 12) can be positioned at the front side of an exposed part 88 of the metal rule feeding path 30.

The base plate driving part 140 then moves the base plate 50 toward the metal rule feeding path 30 with the cutting elements 70a, 70b, 70c, 70d (fixed to the cutter fixing body 75) in a position where they are lifted up by the cutter fixing body 75. This position is where the cutting elements 70a, 70b, 70c, and 70d are outside of and above the cutter holes 66a, 66b, 66c, and 66d of the first plate 40.

As the base plate 50 is moved toward the metal rule feeding path 30, the first plate 40 (which has the cutter holes 66a, 66b, 66c, and 66d formed on it) moves to a position below the flanged side 112 of the metal rule 110, and the selected cutting element (e.g., 70d in FIG. 12) moves to a position above the flanged side 112 of the metal rule 110. That is, the selected cutting element 70d and its corresponding cutter hole 66d are disposed at opposite sides of the flanged side 112 of the metal rule 110.

In this state, a pusher 77 positioned at the rear of the metal rule feeding path 30 is driven so that the metal rule 110 is pushed close to the first plate 40 and tightly adheres to the cutting element. The second cylinder 80 is then driven to press the cutter fixing body 75 down so that the cutting elements 70a, 70b, 70c, and 70d descend toward the cutter holes 66a, 66b, 66c and 66d. This action punches and cuts the flanged side 112 of the metal rule 110 between the cutting element 70d and the cutter hole 66d. In some embodiments, a separate cylinder rod can be used as the pusher 77. After the initial cutting is carried out as described above, the device 20 with multiple cutting elements and the pusher 77 return to their original positions. The metal rule 110 is then moved, and subsequent cutting(s) is carried out using the same procedure as that of the initial cutting.

When another cutting element is desired to be selected, the amount of rotation of the motor 63 (or equivalently, the amount of rotation of the timing belt 65) is controlled in accordance with a predetermined program. Therefore, another cutting element can be selected automatically.

Once the cutting operation as described above is finished, the metal rule is fed into the metal rule folding unit 101 for a folding operation. As described, in one embodiment, cutting and folding operations produce channel letters for sign boards.

The above descriptions of the disclosed embodiments are provided to enable any person skilled in the art to make or use the invention. Various modifications to these embodiments will be readily apparent to those skilled in the art, and the generic principles described herein can be applied to other embodiments without departing from the spirit or scope of the invention. Thus, it will be understood that the description and drawings presented herein represent embodiments of the invention and are therefore representative of the subject matter which is broadly contemplated by the present invention. It will be further understood that the scope of the present invention fully encompasses other embodiments that may become obvious to those skilled in the art and that the scope of the present invention is accordingly limited by nothing other than the appended claims.

For example, although it has been described in the present invention that four cutting elements 70a, 70b, 70c, and 70d having different shapes are provided on a first plate, it is to be understood that the present invention is not limited to such a structure. Two or more cutting elements can be provided on a plate of any shape (e.g., rectangular), and the plate can also be rotationally or non-rotationally driven to select a cutting element.

Further, it has been described in the present invention that the first gear 62 and the second gear 64 are provided to rotate the first plate 40. However, the motor 63 may be provided on the base plate 50 so that the center part of the first plate 40 can be fixed directly to the axle of the motor 63.

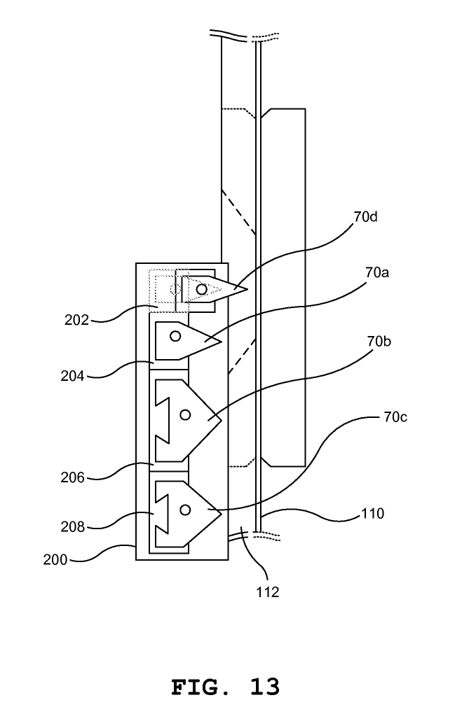

Although the cutting elements 70a, 70b, 70c, and 70d have been described as being operated in a circular configuration, cutting elements may be configured in any shape that allows selection of at least one cutting element for cutting the flanged side of the metal rule. For example, cutting elements may be lined up linearly as shown in FIG. 13.

In the illustrated embodiment of FIG. 13, the cutting elements 70a, 70b, 70c, and 70d are disposed on a rectangular plate 200 with each cutting element configured as a moveable block. For example, the cutting element 70d is disposed on a moveable block 202, the cutting element 70a is disposed on a moveable block 204, the cutting element 70b is disposed on a moveable block 206, and the cutting element 70c is disposed on a moveable block 208. In the illustrated configuration, the moveable block 202 is shown as being selected to be in position to cut the flanged side of the metal rule.

Accordingly, the foregoing embodiments are merely presented as examples and are not to be construed as limiting the present invention. The present teachings can be readily applied to other types of apparatus and/or devices. The description of the present invention is intended to be illustrative, and not to limit the scope of the claims. Many alternatives, modifications, and variations will be apparent to those skilled in the art.

What is claimed is:

1. A device, comprising:
a base plate configured to be moveable toward and back from a metal rule having at least one flanged side,
wherein said metal rule is fed into the device along a metal rule feeding path;
a first plate coupled to said base plate, said first plate including a plurality of cutter holes formed on its surface;
a plurality of cutting elements configured to engage the corresponding plurality of cutter holes on said first plate to make cuts on the at least one flanged side of the metal rule.
